(19) United States
(12) Patent Application Publication
(10) Pub. No.: US 2005/0286716 A1
(43) Pub. Date: Dec. 29, 2005

(54) Wireless headset having charging control module and method thereof

(75) Inventor: Chang-Chung Hou, Hsintien City (TW)

Correspondence Address: TROXELL LAW OFFICE PLLC, SUITE 1404, 5205 LEESBURG PIKE, FALLS CHURCH, VA, 22041, US

(73) Assignee: Huges Hi-Tech Inc.

(21) Appl. No.: 10/867,663

(22) Filed: Jun. 16, 2004

(51) Int. Cl. H04M 1/00; H04M 9/00

(52) U.S. Cl. 379/430

(57) ABSTRACT

A wireless headset has a main unit and a battery module. A first and second sockets are arranged on the main unit and used for plug-in of the battery module. The main unit further has a charging control module. The charging control module has of a first voltage detector, a second voltage detector, a charger, a first switch, a second switch, a third switch and a fourth switch. The charging control is implemented by inputting the battery module or the DC adapter to one of the first and second sockets, and then determining the input voltages of the first and second sockets, respectively, by the first and second voltage detectors to control correspondingly the conductive state of the first, second, third and fourth switches, thus enabling the DC adapter to charge the battery module via the charger.

### BACKGROUND OF THE INVENTION

1. Field of the Invention

The invention is related to a wireless headset, more particularly to a wireless headset that has a detachable battery module.

2. Background of the Invention

Traditionally, a wireless headset can be used to receive and transmit signals in a wireless manner. However, the power supply of the wireless headset generally is offered by a built-in battery. When the power is exhausted, the user has to take off the headset from his ears to charge the battery. The conventional charging method is to use an external power supply to charge the battery disposed inside the wireless headset via a fixed portion of the headset.

However, charging up the headset via a fixed portion may result in some problems; for example, if a user wants to use the wireless headset during charge, the user will be limited to wear the headset on his right or left ear. That is inconvenient.

Accordingly, in order to solve the above problems of the conventional wireless headset that the wireless headset can only be charged via a fixed portion, the present inveniont provides a wireless headset having a ditachable battery with a charge control module and method thereof.

### SUMMARY OF THE INVENTION

The main object of the invention is to provide a wireless headset having a charging control module and a method thereof, in which the battery is designed as a detachable component. Thus, the wireless headset can be worn on a right or left ear during use and won't be limited in the plug-in direction during charging the battery.

In order to achieve the above objects, the present invention provides a wireless headset having a main unit which includes a first socket, a second socket, a charging control module and a wireless communication module. The charging control module is electrically connected between the first and second sockets and the wireless communication module. A battery module can be plugged in the first or second socket as a detachable component to offer the power supply.

During use of the previously mentioned wireless headset, the battery module can be plugged in and connected to the first or second socket so that the wireless headset can be worn on right or left ear.

In order to achieve the above objects, the present invention further provides a charging control module for the wireless headset, comprising a first input terminal, for inputting a first voltage; a second input terminal, for inputting a second voltage; a charger; a first switch, electrically coupled between the first input and the input of the charger; a second switch, electrically coupled between the first input and the output of the charger; a third switch, electrically coupled between the second input and the input of the charger; a fourth switch, electrically coupled between the second input and the output of the charger; a first voltage detector for detecting the level of the first voltage to control the second and third switches; and a second voltage detector for detecting the level of the second voltage to control the first and fourth switches.

In the previously mentioned wireless headset, the charging control module is not subject to the limitation of plug-in direction when the battery is charged, thus the battery module and DC adapter can be alternatively connected to the first and second inputs, respectively; and the first and second voltage detectors can automatically determine whether the first or second inputs are connected to the battery or DC adapter and offer a conductive loop to enable the DC adapter to charge the battery module by the charger, thus enabling the wireless headset to be charged without the limitation of a plug-in direction.

In order to achieve the above objects, the present invention provides a charging control method for a wireless headset. The wireless headset is provided with a first socket, a second socket and a charger; the first and second socket can be used to connect a battery or a DC adapter. Two switch-controlled loops are arranged between the input and output of the charger to the first to second sockets, respectively. The charging control method comprises the following steps. The battery module and the DC adapter are inserted into one of the first and second sockets, respectively. Whether the input voltage of the first or second socket is larger than a predetermined value is determined. The socket, either the first or second, whose input voltage is larger than the predetermined value is selected to close the switch located between the selected socket and the input of the DC adapter. The socket, either the first or the second, whose input voltage is less than the predetermined value is selected to close the switch located between the selected socket and the output of the DC adapter. The DC adapter then charges the battery module via the charger.

The features and technical contents of the present invention will become apparent from the detailed description of the present invention with reference to the accompanying drawings, the detailed description and drawings are intended to be illustrative and not restrictive.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view of the wireless headset according to this invention;

FIG. 2 is a view for illustrating the status of charging the wireless headset according to this invention;

FIG. 3 is a block diagram of the wireless headset according to this invention;

FIG. 4 is a block diagram of the charging control module according to this invention; and

FIG. 5 is a circuit diagram of the charging control module according to this invention.

### DESCRIPTION OF THE PREFERRED EMBODIMENT

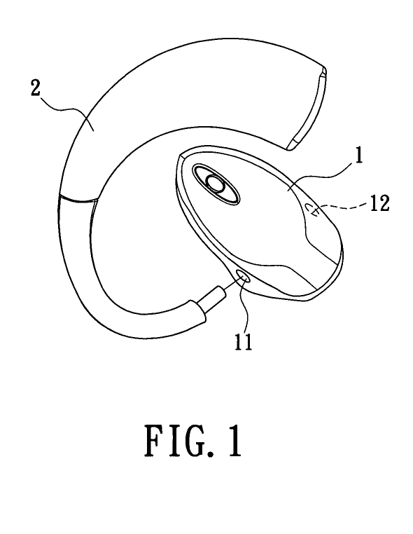

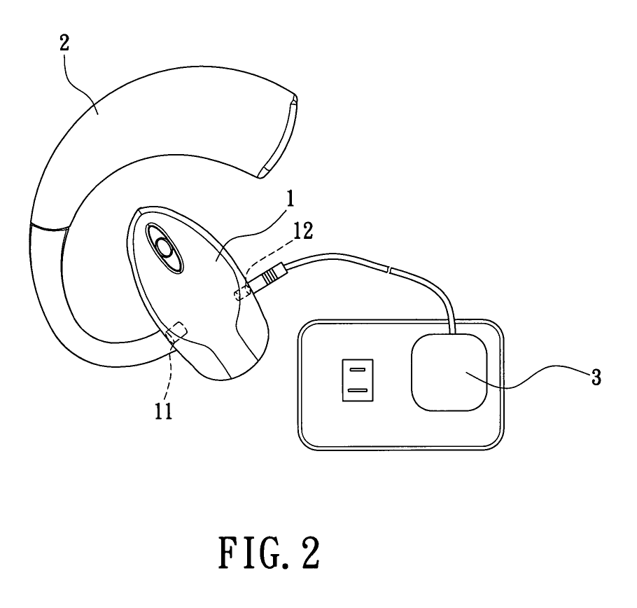

With reference to both FIGS. 1 and 2, the wireless headset according to the present invention comprises a main unit 1 and a battery module 2. A first socket 11 and a second socket 12 are arranged respectively at the right and left sides of the main unit 1, the battery module 2 can be plugged in the first or second socket 11 or 12 in a detachable manner, wherein the battery module 2 can be used to wear on an ear. When the battery module 2 is plugged into the main unit 1, the battery module 2 provides electric power for the main unit 1 to enable the main unit 1 to operate normally. Further, since the battery module 2 can be plugged into the first or second socket 11 or 12, the user has a choice of wearing the wireless headset on his/her right or left ear as required.

With reference to FIG. 2 again, the battery of the battery module 2 is preferred to be a rechargeable battery and can be charged by the DC adapter 3. The charging method of the present invention is to arbitrarily plug the charger module 2 and the DC adapter 3 into the first socket 11 and the second socket 12 respectively. In FIG. 2, the battery module 2 is plugged into and connected to the first socket 11 and the DC adapter 3 is plugged into and connected to the second socket 12. The power output from the DC adapter 3 is appropriately processed in the main unit 1 and supplied to charge the battery module 2. However, the present invention is not limited to the connection manner illustrated in FIG. 2, and the plugged positions of the battery module 2 and the DC adapter 3 can be exchanged to perform the same charging operation.

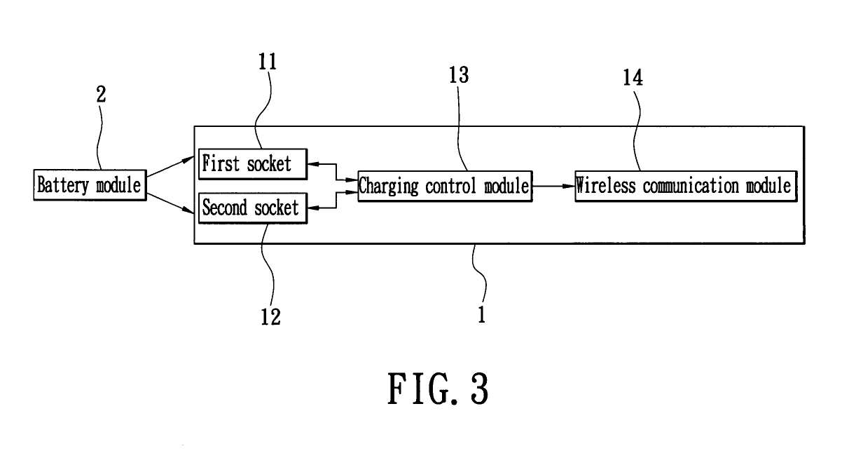

With reference to FIG. 3, a block diagram of the wireless headset of the present invention is shown. In addition to the previously mentioned first and second sockets 11 and 12, the main unit 1 comprises a charging control module 13 and a wireless communication module 14. The charging control module 13 is electrically connected between the first socket 11, the second socket 12 and the wireless communication module 14. The charging control module 13 can charge the battery module 2 and provide a conductive loop to enable the battery module 2 to supply power to the wireless communication module 14. The charging control module 13 will be described below in detail. The wireless communication module 14 receives and sends the speech sounds from/to the outside to perform receiving and sending speech operations for the wireless headset.

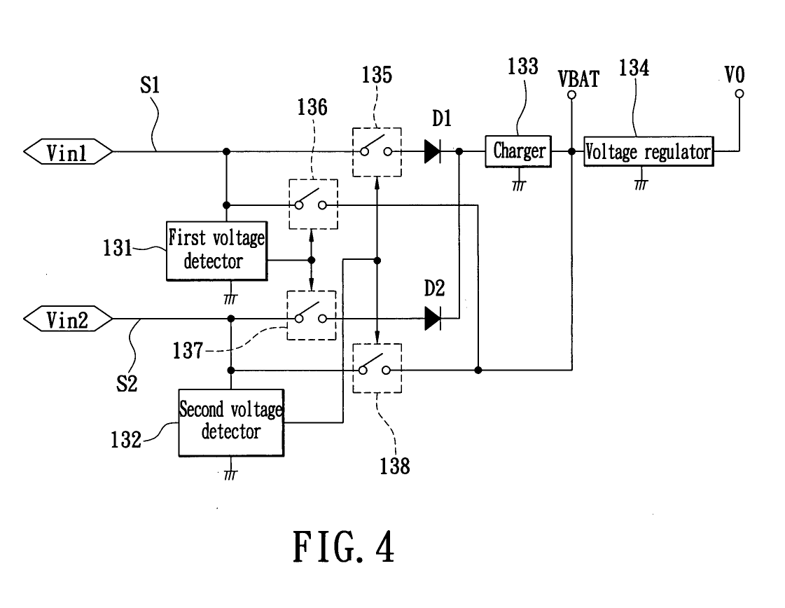

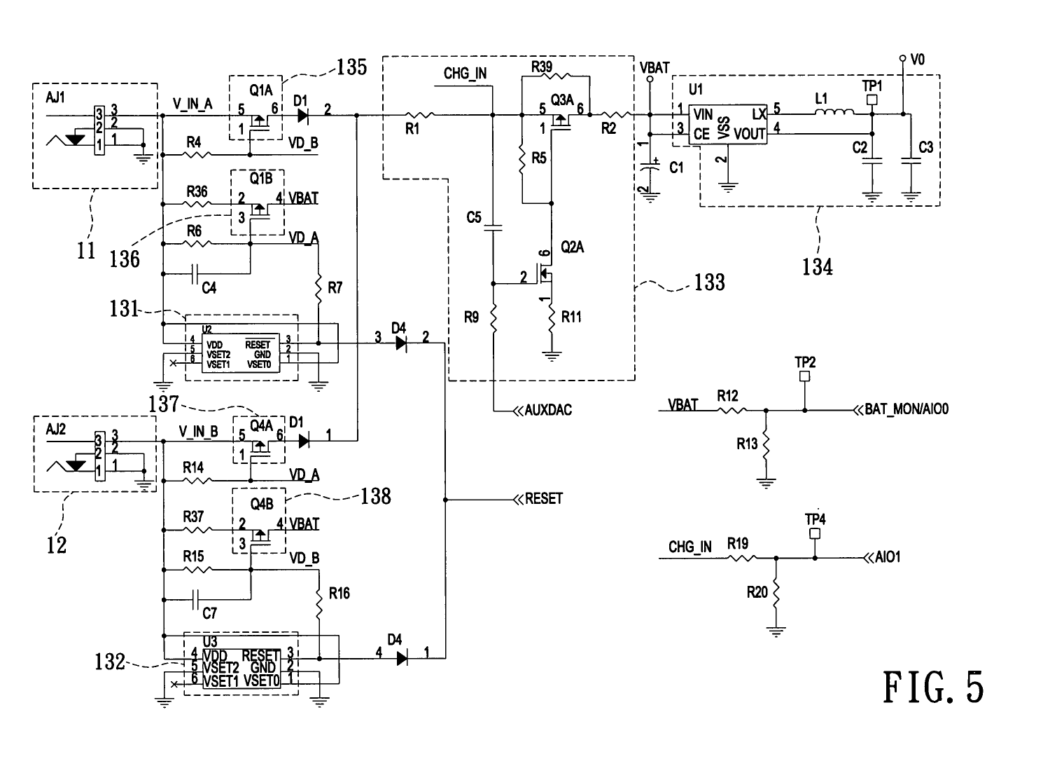

With reference to both of FIGS. 4 and 5, this is a block view and circuit diagram of the charging control module according to the present invention. The charging control module 13 comprises a first voltage detector 131, a second voltage detector 132, a charger 133, a voltage regulator 134, a first switch 135, a second switch 136, a third switch 137 and a fourth switch 138. The previously mentioned first switch 135 is electrically connected between the first input S1 and the input of the charger 133; the second switch 136 is electrically connected between the first input S1 and the output of the charger 133; the third switch 137 is electrically connected between the second input S2 and the input of the charger 133; and the fourth switch 138 is electrically connected between the second input S2 and the output of the charger 133. The first switch 135, the second switch 136, the third switch 137 and the fourth switch 138 preferably are MOS transistor illustrated in FIG. 5.

To avoid the direct break-over between the first and second inputs S1 and S2, protective components are arranged between the first and third switch 135, 137 and the input of the charger 133, such as the diode D1 and D2 illustrated in FIG. 4.

The first input S1 obtains the input of a first voltage Vin1 from the first socket 11, and the second input S2 obtains the input of a second voltage Vin2 from the second socket 12. The first voltage detector 131 is used to detect the level of the first voltage Vin1 input from the first input S1 and determine the level value of the first voltage Vin1, and further control the close or open state of the second switch 136 and the third switch 137. The second voltage detector 132 is used to detect the level of the second voltage Vin2 input from the second input S2 and determine the level value of the second voltage Vin2, and further control the closed or open state of the first switch 135 and the fourth switch 138.

Generally, the battery module according to the invention offers levels ranging from 3.6V-4.2V, and the DC adapter 3 offers the battery module 2 with a charging level of 5V. Therefore, in order to identify whether the battery module 2 or the DC adapter 3 is plugged into the first and second input S1 and S2, the first and second voltage detectors 131 and 132 make the decision based on the threshold of 4.5V. Taking the first input S1 as an example, if the first voltage detector 131 determines that the first voltage is larger than 4.5V, indicating that the first socket 11 is plugged in and connected to the DC adapter 3 at this time, while the second switch 136 and the third switch 137 enter into the open state under the control of the first voltage detector 131. Otherwise, the first voltage detector 131 determines that the first voltage is less than 4.5V, indicating that the first socket 11 is plugged in and connected to the DC adapter 3 at this time, while the second switch 136 and the third switch 137 enter into closes state under the control of the first voltage detector 131. With respect to the second voltage detector 137, the determination is made in the same way as that of the first voltage detector 131, so a duplicate explanation will be omitted.

When the wireless headset according to the invention is charged, the charging control module 13 performs the following operations. It is supposed that the first input S1 is connected to the battery module 2, and the second input S2 is connected to the DC adapter 3. The first voltage detector 131 determines that the first voltage is less 4.5V, then the second switch 136 and the third switch 137 enter into the closed state under the control of the first voltage detector 131. The second voltage detector 132 determines that the second voltage is larger than 4.5V; thus, the first switch 135 and the fourth switch 138 enter into the open state under the control of the second voltage detector 132. Therefore, in this case where the first switch 135 is open and the second switch 136 is closed, the first input S1 together with the output of the charger 133 form a conductive loop. On the other hand, in the case where the third switch 137 is closed and the fourth switch 138 is open, the second input S2 together with the input of the charger 133 form a conductive loop. As a result, the output source of the DC adapter 3 is input into the input of the charger 133 via the second input S2, and under the control of the charger 133, the charging current is applied to the battery module 2 via the first input S1 for charging the battery.

On the other hand, a voltage regulator 134 is electrically connected to the output of the charger 133, and when the battery module 2 is plugged into and connected to the first or second input S1 or S2, the output source VBAT of the battery module 2 can output a stable working power supply to the wireless communication module 14 via the voltage regulator 134.

Therefore, the wireless headset and charging control module according to the invention are characterized by the design of battery module 2 as a detachable component. This enables the wireless headset to be convenient for wearing on the right or left ear of the user. Additionally, the first and second socket 11 and 12 are arranged on the main unit 1. The first socket 11 is available for the battery module 2 or DC adapter 3; especially during charging the wireless headset, the battery module 2 and the DC adapter 3 can either be plugged into the first socket 11 or the second socket 12 at will. The charging control module 13 within the main unit 1 can automatically determine whether the battery module 2 or the DC adapter 3 is plugged in and connected to the first and second socket 11 and 12, thus enabling the DC adapter 3 to smoothly charge the battery module 2 under the control of the charging control module 13.

In conclusion, this invention fully meets the requirements for the patent application. Therefore, the application is proposed according to the patent law, it is desired that the invention will be obtained early, so as to protect the right of the inventor. If there is any question, please tell us.

With reference to the drawings, the description has been given above merely for one of preferred embodiments of this invention, those skilled in the art will appreciate numerous modifications and variations therefrom. It is intended that the appended claims cover all such modifications and variations as fall within the spirit and scope of this present invention.

1. A wireless headset, comprising:
a main unit, having a first socket, a second socket, a charging control module and a wireless communication module, wherein the charging control module is electrically connected between the first socket, the second socket and the wireless communication module; and
a battery module formed as a detachable component plugged in and connected to the first or second socket to supply power for the main unit.

2. The wireless headset as claimed in claim 1, wherein the charging control module comprises:
a charger;
a first switch, electrically connected between the first socket and an input of the charger;
a second switch, electrically connected between the first socket and an output of the charger;
a third switch, electrically connected between the second socket and the input of the charger;
a fourth switch, electrically connected between the second socket and the output of the charger;
a first voltage detector for detecting a voltage level at the first socket to control the second and third switches; and
a second voltage detector for detecting a voltage level at the second socket to control the first and fourth switches.

3. The wireless headset as claimed in claim 2, wherein the first, second, third and fourth switches are MOS transistors.

4. The wireless headset as claimed in claim 2 further having a protective component, which electrically connects the first switch with the input of the charger module or connects the third switch with the input of the charger module.

5. The wireless headset as claimed in claim 4, wherein the protective component is a diode.

6. The wireless headset as claimed in claim 2 further comprising a voltage regulator electrically connected to the output of the charger.

7. The wireless headset as claimed in claim 1, wherein the battery of the battery module is a rechargeable battery.

8. A charging control module of a wireless headset, comprising:
a first input terminal used for inputting a first voltage;
a second input terminal used for inputting a second voltage;
a charger;
a first switch electrically connecting a first input with an input of the charger;
a second switch electrically connecting the first input with an output of the charger;
a third switch electrically connecting a second input with the input of the charger;
a fourth switch electrically connecting the second input with the output of the charger;
a first voltage detector for detecting a level of the first voltage to control the second and third switches; and
a second voltage detector for detecting a level of the second voltage to control the first and fourth switches.

9. The charging control module of the wireless headset as claimed in claim 8, wherein the first, second, third and fourth switches are MOS transistors.

10. The charging control module of the wireless headset as claimed in claim 8 further having a protective component which electrically connects the first switch with the input of the charger module or connects the third switch with the input of the charger module.

11. The charging control module of the wireless headset as claimed in claim 10, wherein the protective component is a diode.

12. The charging control module of the wireless headset as claimed in claim 8, further comprising a voltage regulator electrically connected to the output of a charger module.

13. A charging control method for a wireless headset, wherein the wireless headset is provided with a first socket, a second socket and a charger, the first and second socket are used to connect a battery or a DC adapter, two switch-controlled loops are arranged between the input and output of the charger and the first and second sockets respectively, the charging control method comprising the steps of:
plugging the battery module and the DC adapter into the first or second sockets respectively;
determining whether the input voltage of the first or second socket is larger than a predetermined value;
selecting one of the first and second sockets, whose input voltage larger than the predetermined value, and closing the switch located between the first selected socket and the input of the DC adapter;
selecting one of the first and second sockets, whose input voltage of a second selected socket is less than the predetermined value, and closing the switch between the secondly selected socket and the output of the DC adapter; and
charging the battery module through the charger by using the DC adapter.

14. The charging control method for the wireless headset as claimed in claim 13, wherein the switches are MOS transistors.
